(19) United States
(12) Patent Application Publication
(10) Pub. No.: US 2017/0167684 A1
(43) Pub. Date: Jun. 15, 2017

(54) LAMP FOR VEHICLE

(71) Applicant: Hyundai Motor Company, Seoul (KR)

(72) Inventor: Dong Hoon Choo, Seoul (KR)

(21) Appl. No.: 15/146,266

(22) Filed: May 4, 2016

(30) Foreign Application Priority Data
Dec. 11, 2015 (KR) 10-2015-0177040

(51) Int. Cl. F21S 8/10

(52) U.S. Cl. CPC F21S 48/1358; F21S 48/1275; F21S 48/145; F21Y 2101/02

(57) ABSTRACT

A lamp for a vehicle is provided. The lamp has a reduced cost and weight of the lamp and allows an increased degree of design freedom by reducing a size of an optical system in compensation for a size of the projection lens. Additionally, the lamp for the vehicle increases the efficiency and amount of light since the lamp radiates light using light emitted from the light source without loss of the light.

### CROSS REFERENCE TO RELATED APPLICATION

The present application claims priority to Korean Patent Application No. 10-2015-0177040, filed Dec. 11, 2015, the entire contents of which is incorporated herein for all purposes by this reference.

### BACKGROUND

1) Field of the Invention

The present invention relates to a lamp for a vehicle and more particularly, to a lamp for a vehicle, that enables a size reduction of a lamp module and secures a sufficient amount of light.

2) Description of the Related Art

Generally, a vehicle is provided with a lighting system to allow a driver of the vehicle to view objects ahead of the vehicle, and to allow other drivers to clearly view a driving state of the vehicle during low light conditions. A headlamp, (e.g., a headlight) is a lamp that illuminates the road ahead in a direction in which a vehicle is being driven. In particular, the headlamp requires sufficient brightness to enable a driver to identify impediments on the road up to about 100 m in front of the vehicle during low light conditions.

Recently, due to the development of a high intensity light emitting diode (LED), a headlamp that uses LED technology has been manufactured as a light source of the headlamp. Such a projection-type headlamp provides advantages over a traditional clear-type headlamp in light distribution. Furthermore, an LED headlamp provides a visually appealing design to a frontal area of a vehicle in that the projection-type headlamp allows light to be converged by a reflecting surface or a lens. Light emitted from the light source is reflected by the reflecting surface, and converges to one point arranged in a forward direction from the light source. The converged light is refracted by a refractive lens disposed on a frontal area of an optical system, and thus is emitted in the forward direction.

However, the refractive lens requires substantially large size to secure a sufficient amount of light. Accordingly, to realize a pattern of light that uses the increased size refractive lens, a size of the optical system including the refractive lens and the reflecting surface must also be increased. Furthermore, the refractive lens is configured to emit light to the exterior to allow incident light to be on a refractive area of the refractive lens. However, when light is incident on an area except for the refractive area, a pattern of the light is formed differently from a pattern formed when light is incident on the refractive area. However, to prevent the above-mentioned problem, a separation wall is disposed on the area except for the refractive area. Accordingly, the separation wall causes loss of the light, and increases cost of the system.

The above information disclosed in this section is merely for enhancement of understanding of the background of the invention and therefore it may contain information that does not form the prior art that is already known in this country to a person of ordinary skill in the art.

### SUMMARY

The present invention provides a lamp for a vehicle, having the above-mentioned configuration to decrease cost and weight of the lamp. Further, the reduced a size of an optical system in compensation for a size of a refractive lens provides a greater degree of design freedom, and increases light efficiency by securing a sufficient amount of light.

In one aspect of the present invention, a lamp for a vehicle may include a light source configured to emit light in a forward direction and a reflecting body configured to reflect the light emitted from the light source in the forward direction. The reflecting body may allow a first portion of the light to be reflected in the forward direction via the focal points, and may allow a second portion of the light (e.g., the remainder of the light) to be reflected in linearly in the forward direction. A separation wall may separate the light trajectory after reflection by the reflecting body. A projection lens may be configured to radiate the incident light in a linearly (e.g., straight) in the forward direction wherein the light separated by the separation wall are incident on the projection lens.

The reflecting body may include an oval reflection surface configured to reflect the light emitted from the light source in the forward direction via the focal points and a hyperbolic reflection surface configured to reflect the remaining portion of the light linearly along a forward trajectory (e.g., in the forward direction). The oval reflection surface may include a first focal point in the light source, and may have a second focal point on a virtual line linearly in a forward trajectory from the light source. The hyperbolic reflection surface may be disposed on a front end of the oval reflection surface. Further, the hyperbolic reflection surface may be configured to allow the light source to be a referential focal point and the light emitted from the light source may travel linearly in a forward trajectory.

The projection lens may include a first lens component on which the incident light travels after being reflected by the oval reflection surface and a second lens component on which the incident light travels after being reflected by the hyperbolic reflection surface. The first lens component may be disposed on a center of the projection lens, and the second lens component may be positioned to surround a circumference of the first lens component. The first lens component of the projection lens may include an aspherical lens configured to pass light though the focal points after being reflected by the oval reflection surface to be radiated linearly along a forward trajectory. The second lens component of the projection lens may include a spherical lens configured to radiate the light linearly in the forward trajectory after being reflected by the hyperbolic reflection surface.

The separation wall may be disposed between the first lens component and the second lens component, and may be formed to extend in forward and rearward directions. Accordingly, the separation wall may be configured to reflect light via the oval reflection surface to be incident on the first lens component. Further, the light reflected by the hyperbolic reflection surface may be incident on the second lens component.

The lamp for the vehicle having the above-mentioned configuration may reduce the cost and weight of the lamp. Furthermore, the size of an optical system in compensation for a size of the projection lens may provide for an increased design freedom. Additionally, the lamp for the vehicle may increase the efficiency and amount of light since the lamp may radiate light using light emitted from the light source without the reduction of the light.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exemplary view showing a lamp for a vehicle according to an exemplary embodiment of the present invention;

FIGS. 2 to 4 are exemplary views showing light trajectories in the lamp for the vehicle shown in FIG. 1 accordingly to an exemplary embodiment of the present invention; and

FIG. 5 is an exemplary view showing a conventional lamp for a vehicle according to the related art.

### DETAILED DESCRIPTION

Hereinbelow, an exemplary embodiment of the present invention will be described in detail with reference to the accompanying drawings. Throughout the drawings, the same reference numerals will refer to the same or like parts.

The present invention will be described more fully hereinafter with reference to the accompanying drawings, in which exemplary embodiments of the invention are shown. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

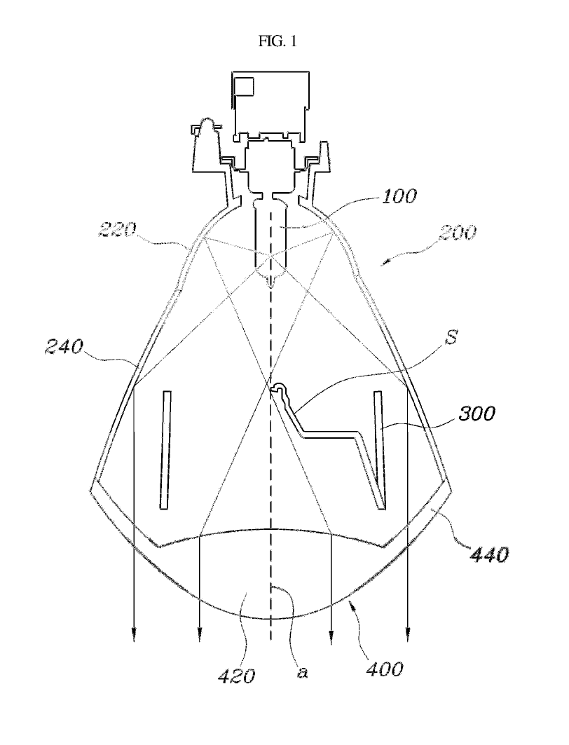

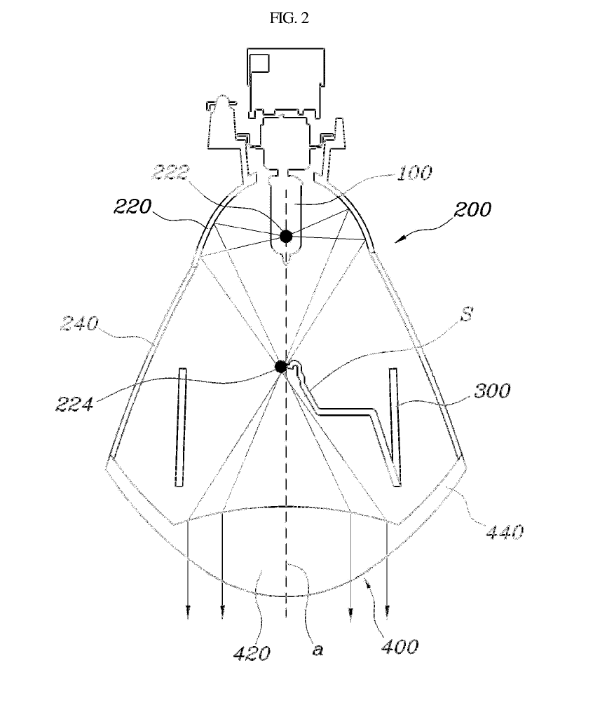

FIG. 1 is an exemplary view showing a lamp for a vehicle according to an exemplary embodiment of the present invention. FIGS. 2 to 4 are exemplary views showing light trajectories in the lamp for the vehicle shown in FIG. 1.

The lamp for the vehicle may include a light source 100 configured to emit light in a forward direction and a reflecting body 200 configured to reflect light emitted from the light source 100 in the forward direction. The reflecting body 200 may be configured to reflect a first portion of the light in the forward direction via the focal points and a second portion of the light may be reflected linearly in the forward direction (e.g., forward trajectory). A separation wall 300 may be configured provide separate light trajectories after reflection by the reflecting body 200. A projection lens 400 may include the light separated by the separation wall 300 incident on the projection lens, and the projection lens 400 may be configured to radiate the incident light linearly in the forward direction.

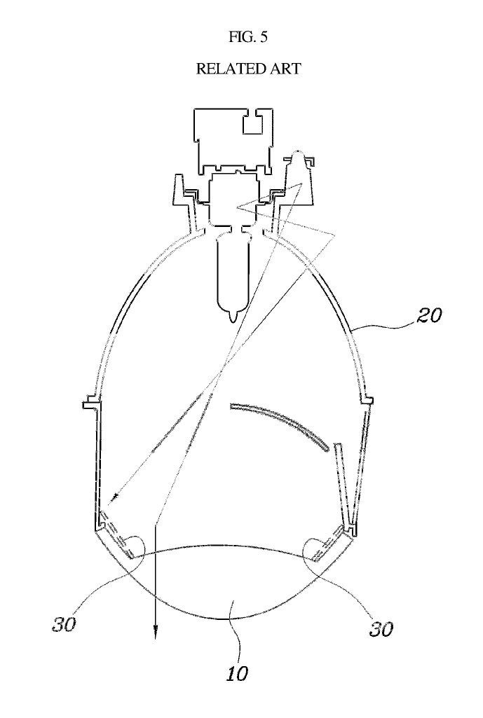

As shown in FIG. 5, a conventional lamp has an increased size of a lamp module since an increased size of a reflecting surface 20 of an optical system is required to correspond to a size of a lens 10. In addition, the lens 10 is configured to radiate incident light on an area to which an aspherical surface of the lens 10 is applied in a forward direction. When incident light is reflected on an area except for the aspherical surface, the light is emitted in an undesirable or unintended direction. Accordingly, a separation wall 30 is disposed on the area except for the aspherical surface of the lens 10, which increases cost of the conventional lamp, decreases light emitted from the light source 100, and decreases light efficiency.

Accordingly, as shown in FIG. 1, of the claimed invention the reflecting body 200 may be configured to reflect light emitted from the light source 100 in the forward direction. For example, a first portion of the light may be reflected in the forward direction via the focal points, and a second portion of the light may be reflected linearly in the forward direction. Furthermore, the projection lens 400 may be configured to radiate the incident light via the focal points linearly in the forward direction, and radiate the light traveling in the forward linear trajectory to maintain the radiation linearly in the forward direction.

In other words, since the reflecting body 200 may be configured to reflect the light emitted from the light source 100 to allow the light to travel in a forward trajectory after being reflected in two different directions, a size of the reflecting body 200 may be reduced. Particularly, the reflecting body 200 may include an oval reflection surface 220 configured to reflect a first portion of the light emitted from the light source 100 in the forward direction via the focal points and a hyperbolic reflection surface 240 configured to reflect the second portion of the light in linearly in the forward direction.

Accordingly, the reflecting body 200 may include the oval reflection surface 220 and the hyperbolic reflection surface 240. The oval reflection surface 220 may include a shape of an oval cut in half or less. For example, when the light emitted from the light source 100 is reflected by the oval reflection surface 220, the reflected light may pass through the focal points, and the hyperbolic reflection surface 240 may extend linearly from the oval reflection surface 220 in a forward direction.

Particularly, as shown in FIG. 2, the oval reflection surface 220 may have a first focal point 222 disposed in the light source 100 and may have a second focal point 224 disposed on a virtual line linearly in a forward direction from the light source 100. In other words, the oval reflection surface 220 may be configured to dispose the first focal point 222 on a virtual line linearly in the forward direction from the light source 100, with the first focal point 222 disposed within the light source 100. Further, the light emitted from the light source 100 in which the first focal point 222 is positioned may through the second focal point 224 positioned ahead of the first focal point 222 on the virtual line a. The projection lens 400 may be configured to enable a second focal point 224 to be a referential focal point of the projection lens 400. To achieve the above-mentioned object, the oval reflection surface 220 may be configured to have a shape of an oval cut in half or less and the light emitted from the light source 100 may be incident on the projection lens 400 via the second focal point 224.

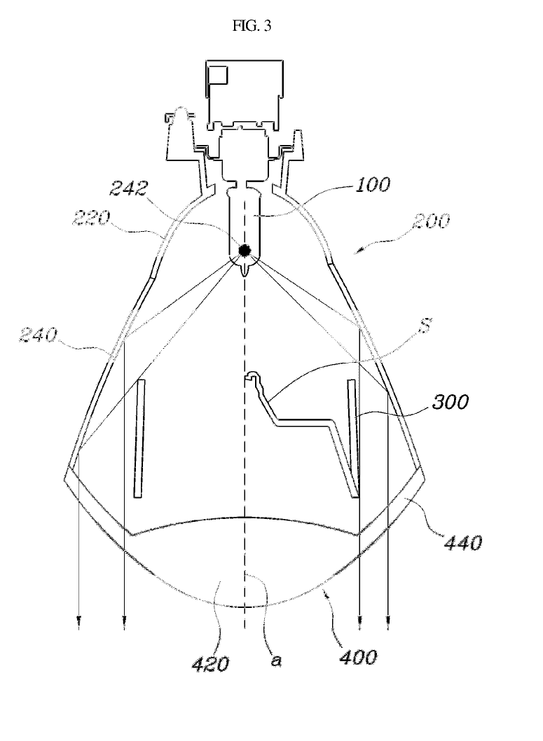

Moreover, as shown in FIG. 3, the hyperbolic reflection surface 240 may be disposed on a front end of the oval reflection surface 220. In particular, the hyperbolic reflection surface 240 may be configured to enable the light source 100 to be a referential focal point 242 of the hyperbolic reflection surface 240 and the light emitted from the light source 100 may travel linearly in the forward direction. For example, the light source 100 may be the referential focal point of the hyperbolic reflection surface 240. The referential focal point of the hyperbolic reflection surface 240 may be disposed on the same area as the first focal point 222 of the oval reflection surface 220 mentioned above. Particularly, the hyperbolic reflection surface 240 may provide a predetermined angle from the front end of the oval reflection surface 220 to extend in a linear trajectory from the front end of the oval reflection surface 220 and may be configured to reflect the light emitted from the light source 100 by the hyperbolic reflection surface 240. The reflected light may be incident on the projection lens 400 after traveling linearly in the forward direction.

The oval reflection surface 220 and the hyperbolic reflection surface 240 of the reflecting body 200 mentioned above may be integrally formed with respect to each other. In particular, when the size of the projection lens 400 of the lamp for the vehicle according to the present invention is the same as a size of the refractive lens 10 of the conventional lamp for a vehicle shown in FIG. 5, the size of the reflecting body 200 may be reduced by configurations of the oval reflection surface 220 and the hyperbolic reflection surface 240. Accordingly, a size and a weight of a lamp module of the lamp according to the present invention may be reduced.

Furthermore, the projection lens 400 may include a first lens component 420 that incident light may pass through after being reflected by the oval reflection surface 220 and a second lens component 440 that incident light may pass through after being reflected by the hyperbolic reflection surface 240. The first lens component 420 may be disposed on a center of the projection lens 400, and the second lens component 440 may be disposed to surround a circumference of the first lens component 420.

In other words, the projection lens 400 may include the first lens component 420 and the second lens component 440. In particular, the oval reflection surface 220 may be configured to reflect incident light via the focal points on the first lens component 420. Additionally, the hyperbolic reflection surface 240 may be configured to reflect incident light linearly in a forward trajectory on the second lens component 440. The projection lens 400 may be configured to emit all of the light linearly in the forward direction.

For example, the first lens component 420 of the projection lens 400 may be disposed at the center of the projection lens 400. Since the light may be reflected by the oval reflection surface 220, the light may pass via the focal points disposed on the virtual line a positioned linearly in the forward direction from the light source 100. The second lens component 440 may be disposed to surround the circumference of the first lens component 420. In particular, a light trajectory reflected by the hyperbolic reflection surface 240 may be different from a light trajectory reflected by the oval reflection surface 220.

Particularly, the first lens component 420 of the projection lens 400 may include an aspherical lens that may be configured radiate light linearly in a forward direction via the focal points after being reflected by the oval reflection surface 220. In other words, the light may be reflected by the oval reflection surface 220 and radiated via the focal points. The first lens component 420 may include the aspherical lens configured to radiate light via the focal points linearly in the forward direction.

In addition, the second lens component 440 of the projection lens 400 may include a spherical lens that may be configured to radiate light linearly in the forward direction after being reflected by the hyperbolic reflection surface 240. In other words, the light trajectory may be reflected by the hyperbolic reflection surface 240 linearly in the forward direction. The second lens component 440 may include the spherical lens that may be configured to radiate the light linearly in the forward direction after being reflected by the hyperbolic reflection surface 240. Accordingly, the spherical lens in cooperation with the aspherical lens mentioned above may enable the light emitted from the light source 100 to be radiate sufficiently. Namely, the lamp according to the present invention may enable the light emitted from the light source 100 to be radiated linearly in the forward direction without loss of the light. In particular, the total amount of light may be radiated without loss of light on any area except for the aspherical lens of the conventional lamp, thereby increasing light efficiency.

Moreover, the separation wall 300 may be disposed between the first lens component 420 and the second lens component 440. Further, the separation wall 300 may be formed to extend in forward and rearward directions. Accordingly, the separation wall 300 may enable the light reflected by the oval reflection surface 220 to be incident on the first lens component 420, and may enable the light reflected by the hyperbolic reflection surface 240 to be incident on the second lens component 440. In other words, as shown in FIGS. 2 to 4, the separation wall 300 may separate various light trajectories after being reflected by the oval reflection surface 220 and the hyperbolic reflection surface 240. The separation wall 300 may be configured to enable the light reflected by the oval reflection surface 220 to be incident on the first lens component 420 after passing through the focal points, and may be configured to enable the light reflected by the hyperbolic reflection surface 240 to be incident on the second lens component 440.

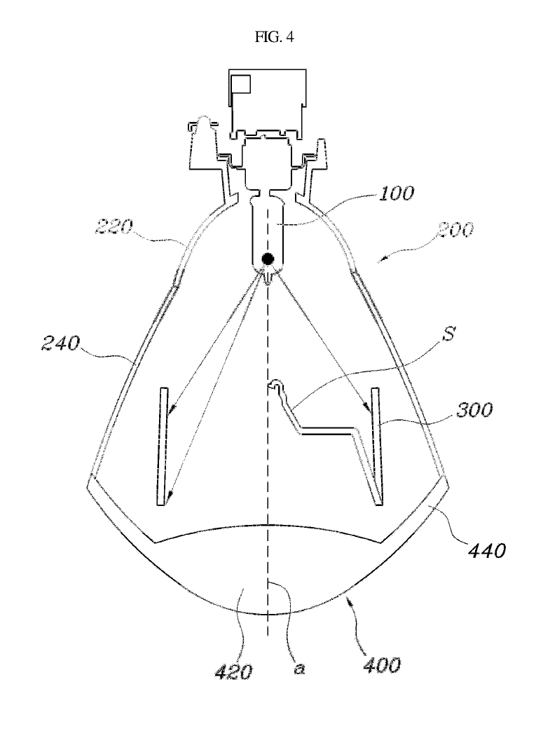

In addition, as shown in FIG. 4, the separation wall 300 may preclude the light emitted from the light source 100 from being directly incident on the second lens component 440 which may enable the light radiated from the projection lens 400 to be radiated linearly in the forward direction. A shield S may be disposed on the separation wall 300 to provide a low beam light. The lamp for the vehicle having the above-mentioned configuration may allow cost and weight of the lamp to decrease and may increase a degree of design freedom by reducing a size of an optical system in compensation for the size of the projection lens 400. Additionally, the lamp for the vehicle may increase efficiency and amount of light the lamp may radiate light by using light emitted from the light source 100 without loss of the light.

While this invention has been described in connection with what is presently considered to be exemplary embodiments, it is to be understood that the invention is not limited to the disclosed exemplary embodiments, but, on the contrary, is intended to cover various modifications and equivalent arrangements, without departing from the scope and spirit of the invention as disclosed in the accompanying claims.

What is claimed is:

1. A lamp for a vehicle, comprising:
a light source configured to emit light in a forward direction;
a reflecting body configured to reflect light emitted from the light source in the forward direction, wherein the reflecting body reflects a first portion of the light in the forward direction via focal points, and linearly reflects a second portion of the light in the forward direction;
a separation wall is configured to separate the light trajectory after reflection by the reflecting body; and
a projection lens, wherein the light separated by the separation wall is incident on the projection lens, and the projection lens is configured to linearly radiate the incident light in the forward direction.

2. The lamp for the vehicle of claim 1, wherein the reflecting body includes:
an oval reflection surface configured to reflect the light emitted from the light source in the forward direction via the focal points; and
a hyperbolic reflection surface configured to reflect the light linearly in the forward direction.

3. The lamp for the vehicle of claim 2, wherein the oval reflection surface comprises:
a first focal point in the light source; and
a second focal point disposed on a virtual line linearly in a forward direction from the light source.

4. The lamp for the vehicle of claim 2, wherein:
the hyperbolic reflection surface is disposed on a front end of the oval reflection surface, and
wherein the hyperbolic reflection surface is configured as a referential focal point of the light source and the light emitted from the light source travels linearly in the forward direction.

5. The lamp for the vehicle of claim 2, wherein the projection lens includes:
a first lens component on which the light traveling after being reflected by the oval reflection surface is incident; and
a second lens component on which the light traveling after being reflected by the hyperbolic reflection surface is incident,
wherein the first lens component is disposed on a center of the projection lens, and the second lens component is disposed to surround a circumference of the first lens part.

6. The lamp for the vehicle of claim 5, wherein the first lens component of the projection lens includes an aspherical lens configured to emit the light via the focal points linearly in the forward direction after being reflected reflected by the oval reflection surface.

7. The lamp for the vehicle of claim 5, wherein the second lens component of the projection lens includes a spherical lens configured to emit the light linearly in the forward direction after being reflected by the hyperbolic reflection surface.

8. The lamp for the vehicle of claim 5, wherein the separation wall is disposed between the first lens component and the second lens component, and is formed to extend in forward and rearward directions, the separation wall configured to disposed incident the light reflected by the oval reflection surface on the first lens component, and configured to disposed incident light reflected by the hyperbolic reflection surface on the second lens component.
